(19) United States
(12) Patent Application Publication
(10) Pub. No.: US 2023/0206369 A1
(43) Pub. Date: Jun. 29, 2023

(54) A System and Method for Awarding Scholarships

(71) Applicant: EM System Solutions, Inc., Jacksonville, FL (US)

(72) Inventors: Joseph Vaudry Sykes, Jacksonville, FL (US); Jeremy David Hurse, Swannanoa, NC (US)

(21) Appl. No.: 18/068,624

(22) Filed: Dec. 20, 2022

Related U.S. Application Data
(60) Provisional application No. 63/291,683, filed on Dec. 20, 2021.

(51) Int. Cl. G06Q 50/20

(52) U.S. Cl. CPC G06Q 50/2053

(57) ABSTRACT

A system and method are described for matching recruited students with available funding opportunities. The system and method comprise a database of recruits, a database of funding opportunities, and a computing device (e.g. mobile phone or personal computer). The method and system match a recruit and a funding opportunity and calculate a metric, such as a tuition discount rate. The discount rate may be calculated for a sport or team or for the university as a whole.

### CROSS-REFERENCE TO RELATED PATENT APPLICATION

The present patent application claims priority to U.S. Provisional Patent Application No. 63/291,683, filed Dec. 20, 2021, and entitled “A System for Awarding Scholarships”, the disclosure of which is incorporated herein by reference thereto.

### BACKGROUND OF THE INVENTION

The present invention relates to efficiently assigning scholarships to non-need-based awardees.

Many universities or other schools award some scholarships not only based on need, but on other matters, for instance on athletic or musical ability. These awards are typically the responsibility of the coach or the musical director, who has many other responsibilities and may not be as experienced in dealing with the regulatory authorities on these matters.

A stacked model of solving the problems of awarding scholarships typically assigns scholarship money first on academic ability, which is measured by such metrics as grade point average and standardized test scores. A second step assigns scholarship money on need-based financial aid, which is controlled by the FAFSA (free application for federal student aid) and regulated by the Department of Education. Lastly, athletic scholarships or musical scholarships may be awarded, limited by a team or activity budget, and subject to regulations from, for instance, the NCAA (National Collegiate Athletic Association).

Accordingly, a need arises for techniques that provide an efficient method for tracking potential awardees, assigning non-need-based scholarships to them, and managing the entire process.

### SUMMARY OF THE INVENTION

The techniques described herein teach a system, method, or computer program product for matching a plurality of recruits with a plurality of funding opportunities. The system may comprise a first database of a plurality of recruits. The system may comprise a second database of a plurality of funding opportunities. The system may comprise a computing device with a display and in communication with the first database and with the second database. The computing device may perform a method comprising the steps of matching, calculating and displaying. The matching step may comprise matching a recruit of the plurality of recruits with a funding opportunity of the plurality of funding opportunities. The calculating step may comprise calculating a metric using the matched recruit and the matched funding opportunity. The displaying step may comprise displaying the calculated metric to a user.

The method or the computer program product may comprise generating a first database of a plurality of recruits. The method or the computer program product may comprise generating a second database of a plurality of funding opportunities. The method or the computer program product may comprise a computing device with a display and in communication with the first database and with the second database. The computing device may perform a method comprising the steps of matching, calculating and displaying. The matching step may comprise matching a recruit of the plurality of recruits with a funding opportunity of the plurality of funding opportunities. The calculating step may comprise calculating a metric using the matched recruit and the matched funding opportunity. The displaying step may comprise displaying the calculated metric to a user.

In embodiments, the computing device may comprise at least one of a mobile phone, a tablet, a desktop computer, a laptop computer, or a notebook computer. In embodiments, the metric may comprise a discount rate. In embodiments, the matching step may further comprise an algorithm to optimize a fitness metric. In embodiments, the method may further comprise tracking an interaction between a recruit of the plurality of recruits and a user and storing a record of the interaction to provide an audit trail. In embodiments, the method may further comprise automatically displaying additional information as the additional information is added to either the first database or the second database.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and the invention may admit to other equally effective embodiments.

FIG. 1 illustrates an exemplary calculation of a team discount rate.

FIG. 2 illustrates an example of an overall process of awarding scholarships.

FIG. 3 illustrates an exemplary approval lifecycle.

FIG. 4 illustrates an exemplary approval route for a recruit.

FIG. 5 illustrates an exemplary approval for each sport.

FIG. 6 illustrates an exemplary overview screen.

FIG. 7 illustrates an exemplary overview screen.

FIG. 8 illustrates an exemplary overview screen.

FIG. 9 illustrates an exemplary profile screen for a user.

FIG. 10 illustrates an exemplary screen for selecting which fields to display.

FIG. 11 illustrates an exemplary general information tab for a particular school.

FIG. 12 illustrates an exemplary years tab for a particular school.

FIG. 13 illustrates an exemplary custom fields tab for a particular school.

FIG. 14 illustrates an exemplary integration tab for a particular school.

FIG. 15 illustrates an exemplary users page.

FIG. 16 illustrates an exemplary set of fields to display for the users page.

FIG. 17 illustrates an exemplary sports page.

FIG. 18 illustrates an exemplary sport general information page.

FIG. 19 illustrates an exemplary recruits page.

FIG. 20 illustrates an exemplary duplicate checker for the recruit page.

FIG. 21 illustrates an exemplary general information tab for the recruit page.

FIG. 22 illustrates an exemplary financial aid (FA) tab for the recruit page.

FIG. 23 illustrates an exemplary FA documents tab for the recruit page.

FIG. 24 illustrates an exemplary comments tab for the recruit page.

FIG. 25 illustrates an exemplary audit trail tab for the recruit page.

FIG. 26 illustrates an exemplary sports tab for the recruit page.

FIG. 27 illustrates an exemplary awards tab for the recruit page.

FIG. 28 illustrates an exemplary awards page.

FIG. 29 illustrates exemplary fields to display selection for the awards page.

FIG. 30 illustrates an exemplary general information tab for the award page.

FIG. 31 illustrates an exemplary FA awards tab for the award page.

FIG. 32 illustrates an exemplary FA documents tab for the award page.

FIG. 33 illustrates an exemplary audit trail tab for the award page.

FIG. 34 illustrates an exemplary sports tab for the award page.

FIG. 35 illustrates an exemplary reports page.

FIG. 36 illustrates an exemplary reports page with filters.

FIG. 37 illustrates an exemplary support page.

FIG. 38 illustrates an exemplary support chat.

FIG. 39 illustrates an exemplary audit trail page.

FIG. 40 illustrates an exemplary audit log.

FIG. 41 illustrates an exemplary school archives page.

FIG. 42 illustrates an exemplary user archives page.

FIG. 43 illustrates an exemplary recruit archives page.

FIG. 44 illustrates an exemplary award archives page.

FIG. 45 illustrates an exemplary report archives page.

FIG. 46 illustrates an exemplary support archives page.

FIG. 47 illustrates a computing device for use with the described invention.

Other features of the present embodiments will be apparent from the Detailed Description that follows.

### DETAILED DESCRIPTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention. Electrical, mechanical, logical, and structural changes may be made to the embodiments without departing from the spirit and scope of the present teachings. The following detailed description is therefore not to be taken in a limiting sense, and the scope of the present disclosure is defined by the appended claims and their equivalents.

Universities in the United States often assign money for non-need-based financial aid on an ad hoc per team or per student basis. The processes for awarding this money is needlessly complicated because the allocation of resources is divided amongst a central financial authority for the entire school, but then administered by the leaders of the various teams or activities themselves. The result is a set of distorted incentives for coaches who wish to coach and recruit who have to spend time calculating and re-calculating various metrics to which they are held accountable by their own school's administration but also by various regulatory bodies (e.g. the Department of Education) or other organizations (e.g. National Collegiate Athletic Association) which act as de facto regulatory bodies for determining whether student athletes are permitted to compete in certain sports. Each regulatory agency or outside organization may have their own forms to submit to oversee the entire process and these forms may have different requirements for different sports or different levels of competitiveness in each sport.

Many universities use a tuition discount rate (also called simply the discount rate, with a more detailed explanation provided elsewhere in this disclosure) which they use for ranking their own internal sports programs or as a metric for comparison with other schools. Thus coaches are required not only to manage the team, but also to manage the financial metrics upon which their job performance is, in part, dependent.

The system, method, and computer program product described in this disclosure calculates these metrics and allows the user to create hypothetical scenarios for administering various scholarships and awards while still keeping track of all regulatory requirements.

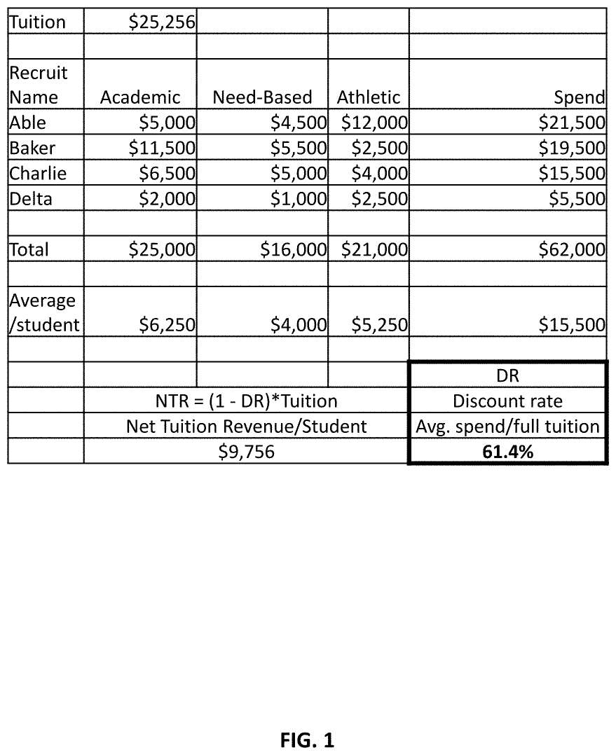

FIG. 1 illustrates an example of the allocation of scholarship money for four individual students and calculation of a discount rate. In this example, the four students (Able, Baker, Charlie, and Delta) may receive a total of $62,000 in awards. In this example, the awards are divided into three categories: academic, need-based, and athletic. Other categories may also be assigned, depending on the activity or the type of sport (e.g. music vs sports or individual/headcount sport vs. equivalency/team sport). Some sports are regulated based on the total number of individuals who receive athletic scholarships (headcount sports) and other sports are regulated based on the average award per team member (equivalency sports). In the example, for student Able, the academic award is $5,000, the need-based award is $4,500, and the athletic award (which may be at the coach's discretion) is $12,000 for a total amount of $21,500. The exemplary full-price tuition is $25,256 which means that student Able receives a discount of $21,500 off the tuition so that student Able's out-of-pocket cost to attend is $25,256-$21,500 =$3,756. Student Delta receives a total of only $5,500,($2,000 academic, $1,000 need-based, and $2,500 athletic) and so will have an out-of-pocket cost to attend of $25,256-$5,500=$19,756. In this example, the coach may highly value both Able and Baker, but know that Baker is a strong student with a GPA and test scores which will qualify him for significant academic financial aid. Thus the coach may decide that rather than spend a significant amount of athletic scholarship funds for Baker, the coach will instead spend the athletic scholarship funds for student Able, who is likely to receive much less academic-based financial aid. The categories given in FIG. 1 are just examples, but in general academic scholarships are awarded based on test scores or academic grades (e.g. grade point average). Need-based scholarships are controlled by the Free Application for Federal Student Aid (FAFSA) forms and information about the student's family (e.g. parental income, number of siblings currently attending college, student income, etc.) The total amount available for athletic scholarships is generally limited by the team budget which is decided centrally by the university administration. But the allocation to individuals is generally left up to the team coach. The new, single allocation method presented in this disclosure may replace the older stacked model of scholarship awards. In this new single model, the athletic awards are determined not just by the team budget, but by valuing ability, character, and team needs and still enabling a user to meet the financial limits of the institution and also the requirements of the regulatory bodies.

Most universities use a discount rate to determine whether the athletic teams are providing value. In this context, the discount rate may mean that fraction of tuition (or annual bill or term bill) which is paid by sources other than the financial aid controlled by the university. Most universities publish a full retail cost of attendance which may comprise tuition, student accommodation (a.k.a. “room” or “rent”), and food (“board”), in addition to other fees. This retail cost to attend is often discounted for individual students in order to entice the students to attend a particular school. In the examples shown in FIG. 1, the student discounts range from a low of $5,500 for student Delta to a high of $21,500 for student Able. The average discount per student in the example is $15,500. In this example, the discount rate would be $15,500/$25,256=61.4% meaning that for these exemplary student-athletes, the full price is discounted by, on average, 61.4% relative to a student paying the full amount. This amount also represents foregone revenue for the university. In the example in FIG. 1, only tuition is considered. As noted elsewhere in this disclosure, the actual cost to attend may comprise additional fees and costs such as room & board, lab fees, parking fees, library fees, and the like.

The system and method disclosed here allow for the user to choose their own preferred financial metric or other metric. For instance, a student with a full academic scholarship (e.g. a national merit scholarship winner) may have a discount rate of 0% since their academic scholarship may cover the full price of attending the university. The university is not discounting the term fees at all for this student. None of the student's tuition is discounted when counting only dollars the university receives from outside sources. 100% of the tuition is paid from outside money. Since the university itself is responsible for the scholarship monies it is managing—the academic, need based, and athletic scholarships in the example cited above—the university thus discounts the tuition it is supposed to receive by this rate to determine the actual percentage that a team's players are paying from non-university sources.

The university financial authorities may wish to calculate the net tuition rate for each athletic team or activity. For example, if a team's discount rate per student is 55%, then the net tuition revenue to the university for students on that team (i.e. the amount of money the university will receive from outside sources) is simply the total tuition price times one minus the discount rate. In an example, if tuition is $20,000 and the discount rate is 55%, then this team's students pay the university on average $9,000 (=$20,000(1 — 0.55)) per student. Multiplying this average student payment by the number of athletes (say 100) yields $900,000 in revenue to the university rather than the $2 million in revenue that the equivalent number of students without any scholarships would pay the university to attend. By thus managing the scholarships awarded to recruited athletes, the financial goals for each team's discount rate or the overall university's goal for student-athletes' discount rate may be met or managed by the team coach, university administrator or other user. In addition, integrating the entire scholarship awarding process may result in other resource savings. For instance, the efficiency of filing regulatory (or de facto regulatory) reports when using this system may also be increased. Another addition benefit may be to increase the retention of student athletes.

The roll date is a date that may be selected in the setup phase to determine when to allow the users to roll their awards to the next academic year without having to recreate each award in the system all over again. When that date hits, a roll or hold button may appear to the right of each award record allowing the user to confirm that the same award should continue for that student for the next academic year. If the user does not wish for the award to automatically roll to the next academic year, then the hold button may be selected.

Typically, the senior management of the university determine how the discount rate (DR) is calculated and then management of each team's funding is left to the team coaches. For example, if the university-wide DR is too high, the overall tuition revenue is negatively impacted and the cost of acquisition for each student-athlete is greater. Conversely, if the DR is set too low, the school may not be able to attract qualified students in competition with other schools vying for the same students. At the team level, each coach may also be given a DR for that team, and then need to manage the team's discount rate.

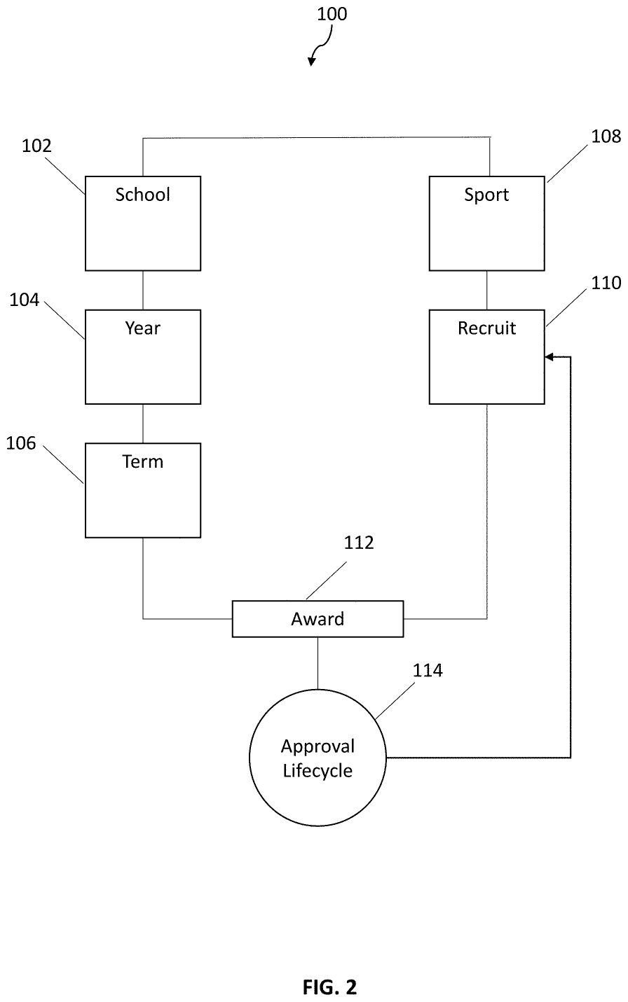

FIG. 2 depicts part of the overall process of selecting recruited students and awarding them scholarships. The evaluation and tracking system 100 contains several elements. For a particular school 102, each year 104 is broken down into terms 106. Likewise, each sport 108 may have many recruits 110. The overall goal is to match a potential award 112 to a recruit 110 and then to proceed to the approval lifecycle 114.

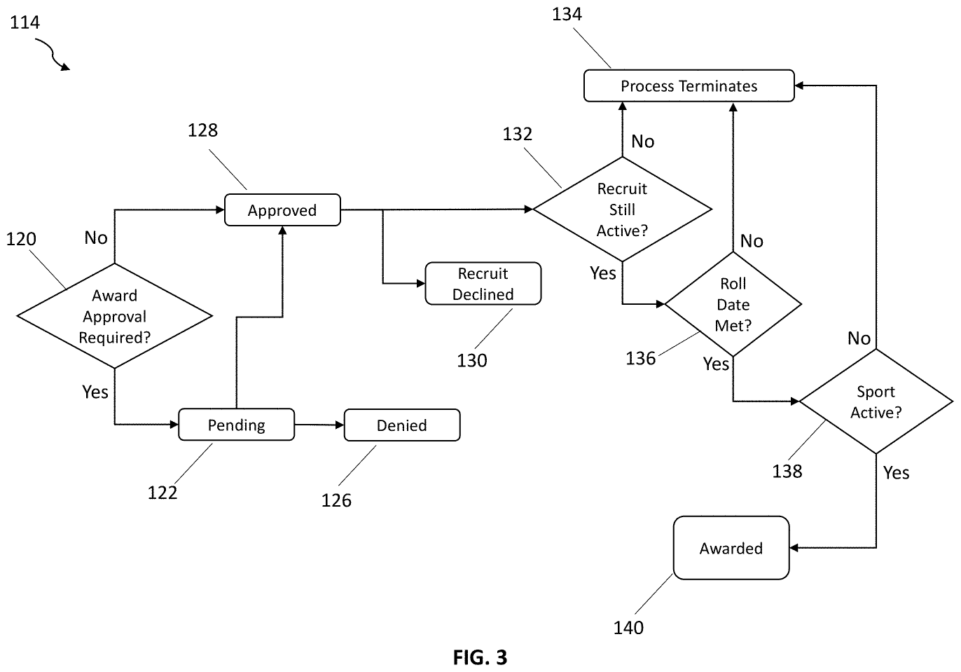

FIG. 3 depicts a flowchart of an exemplary approval lifecycle 114. At step 120, it is determined whether approval is required for the award. If the answer is no, then at 128 the award is approved. If the award does require approval, then at step 122, the award is pending. If the award is not approved, then at step 126, the award is denied. If the award moves from pending to approved, at step 128, the award is approved. If the recruit declines to accept the award, then at step 130, the recruit has declined the award and no scholarship is awarded to that recruit. An award may be “denied” or be assigned to another status, as desired by a user. At step 132 the recruit is evaluated for whether they are still an active recruit. If the answer is no, then at step 134, the process terminates. If the answer is yes, then the process proceeds to step 136, where the question whether the roll date has been met. If at 136, the answer is no, then the process proceeds to step 134, termination. If the roll date has been met at step 136, then the process proceeds to answer whether the sport is active at step 138. If the answer is no, then the process terminates at step 134. If the answer is yes, then the scholarship is awarded at step 140.

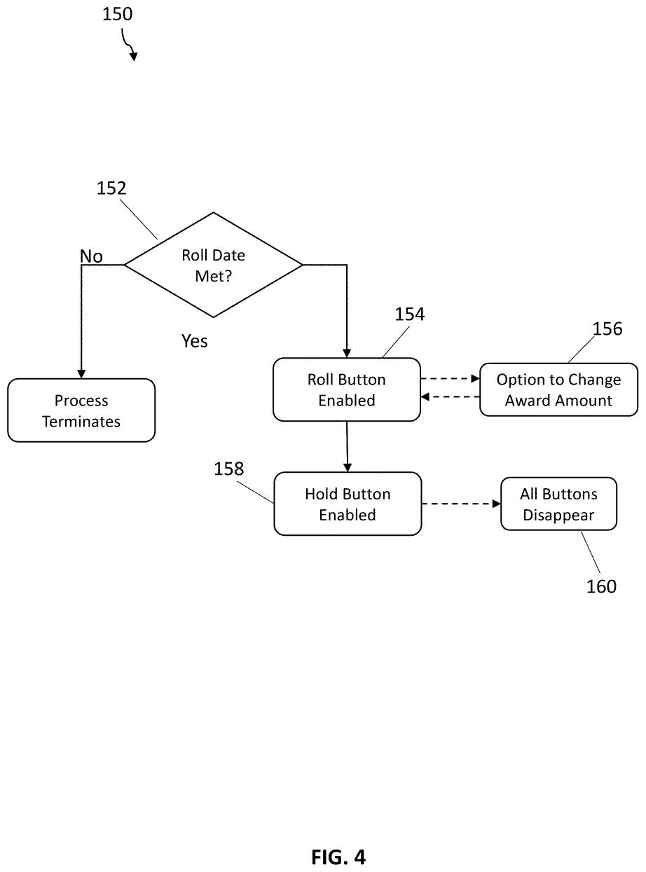

An exemplary recruit process 150 is illustrated in FIG. 4. At step 152, the question is answered whether the roll date has been met. If the roll date has not been met, then the process terminates. If the roll date has been met, then at 154, the roll button is enabled. There is an option to charge the amount of the scholarship 158 if the coach wishes to do so. Once the roll button has been enabled, then the process proceeds to step 156, at which the hold button is enabled and all the buttons disappear.

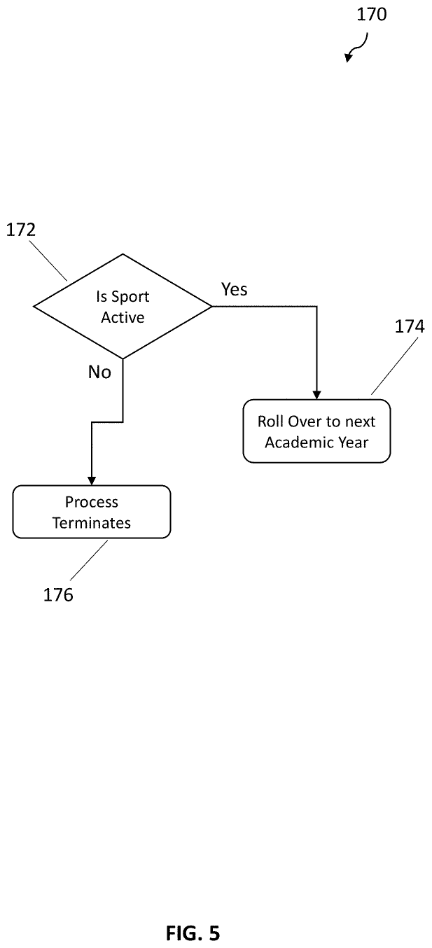

An exemplary per sport process 170 is illustrated in FIG. 5. At step 172, the question is answered whether the sport is active. If the answer is no, the process terminates. If the answer is yes, then the process proceeds to step 174, roll the recruit over to the next academic year. When this occurs, step 176, is to be determined.

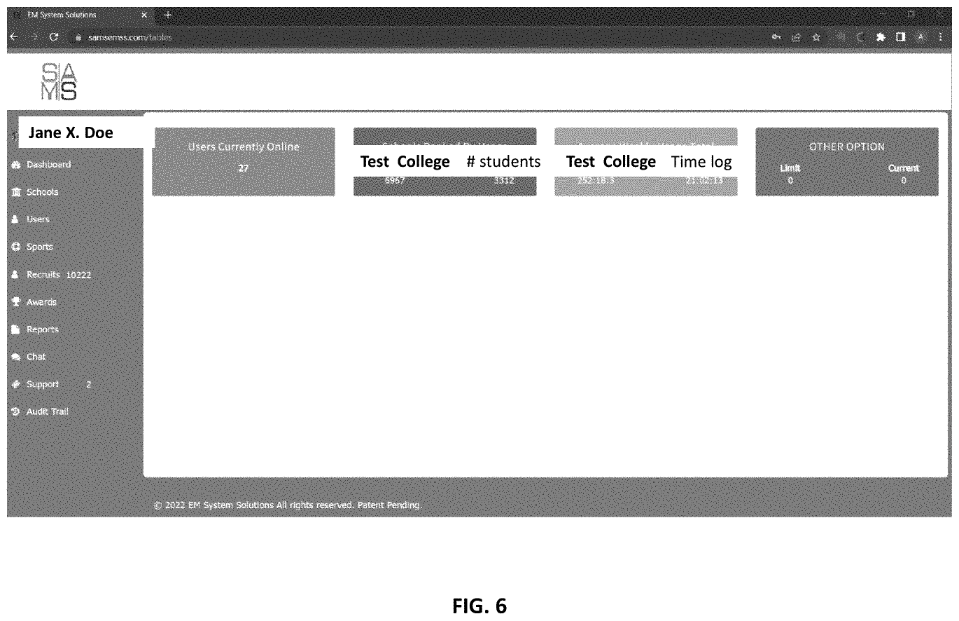

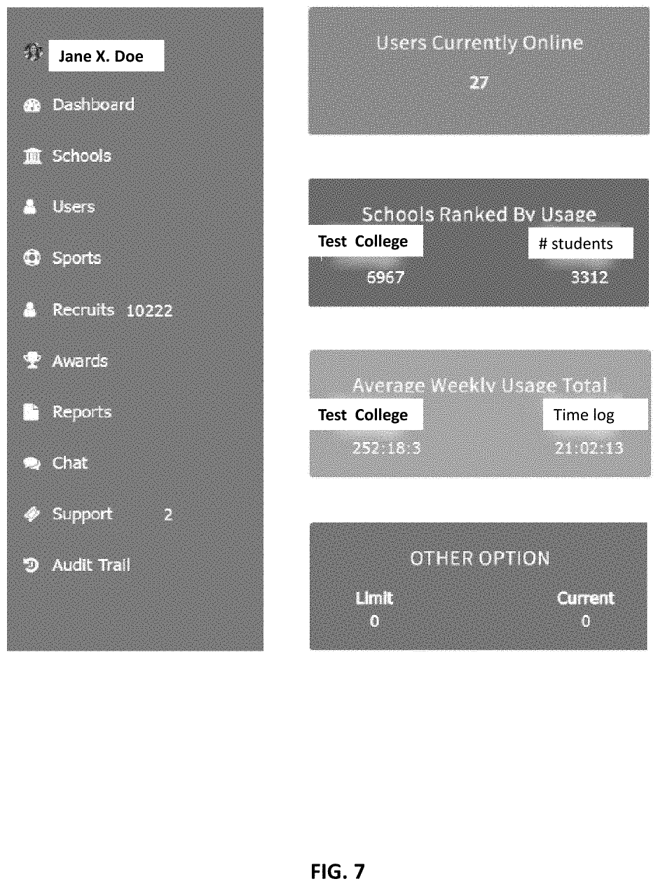

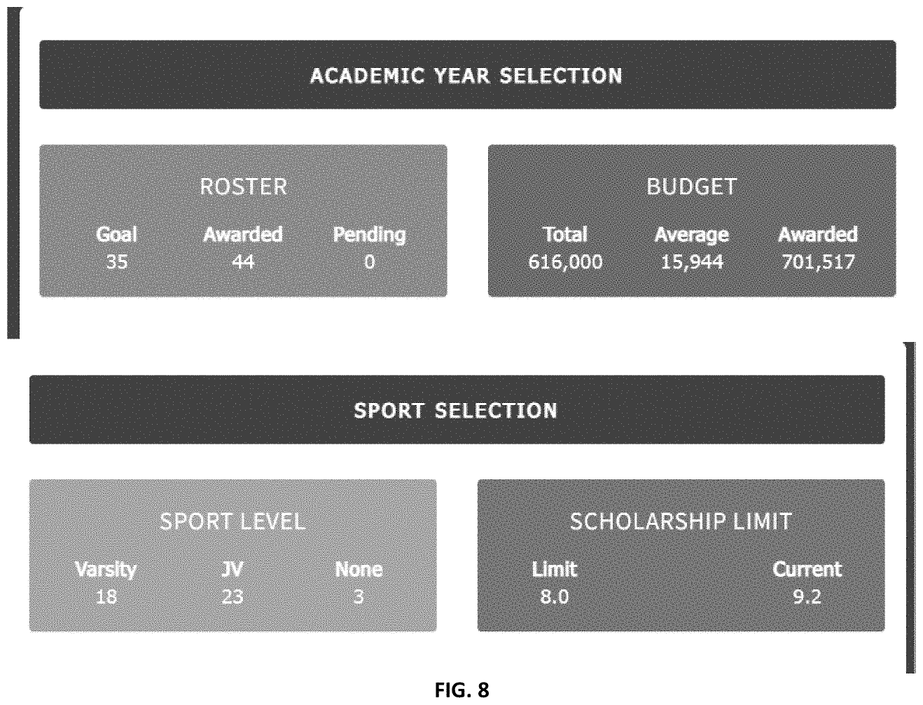

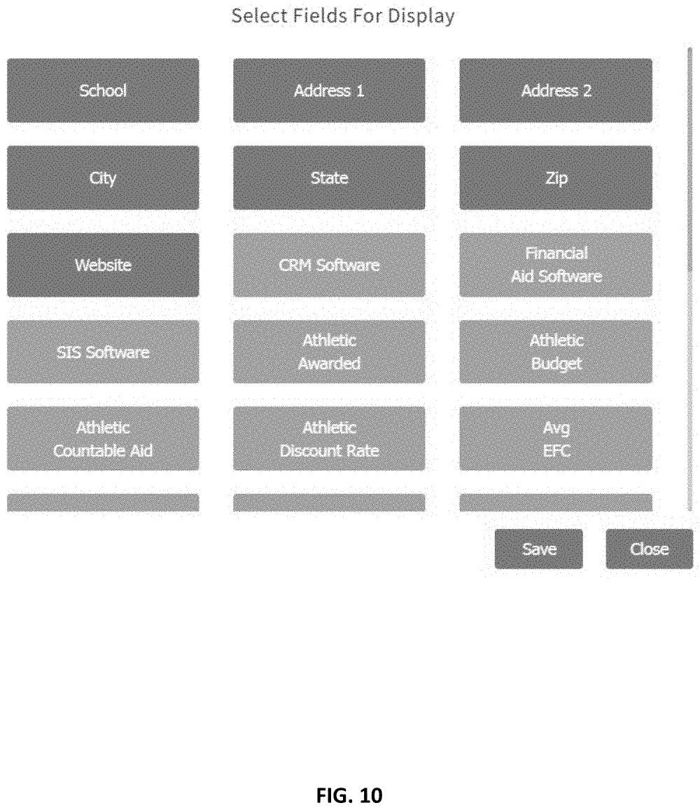

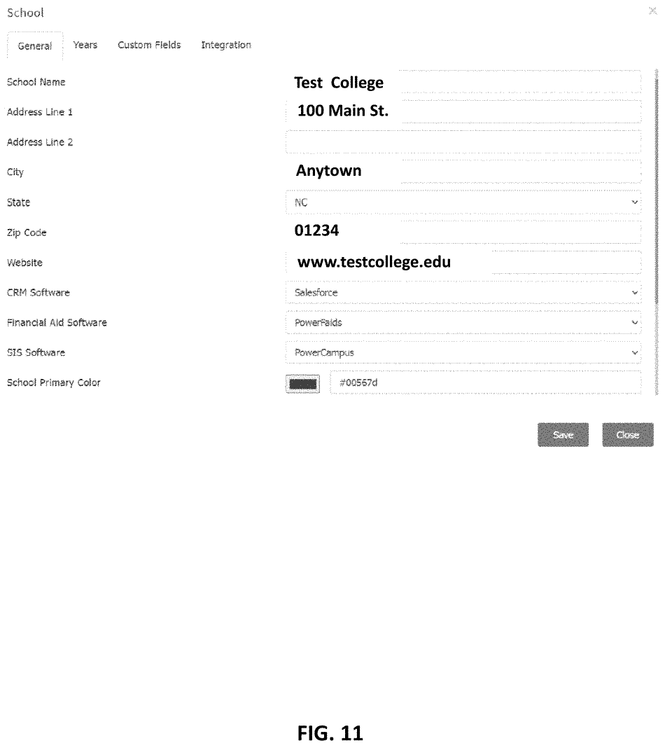

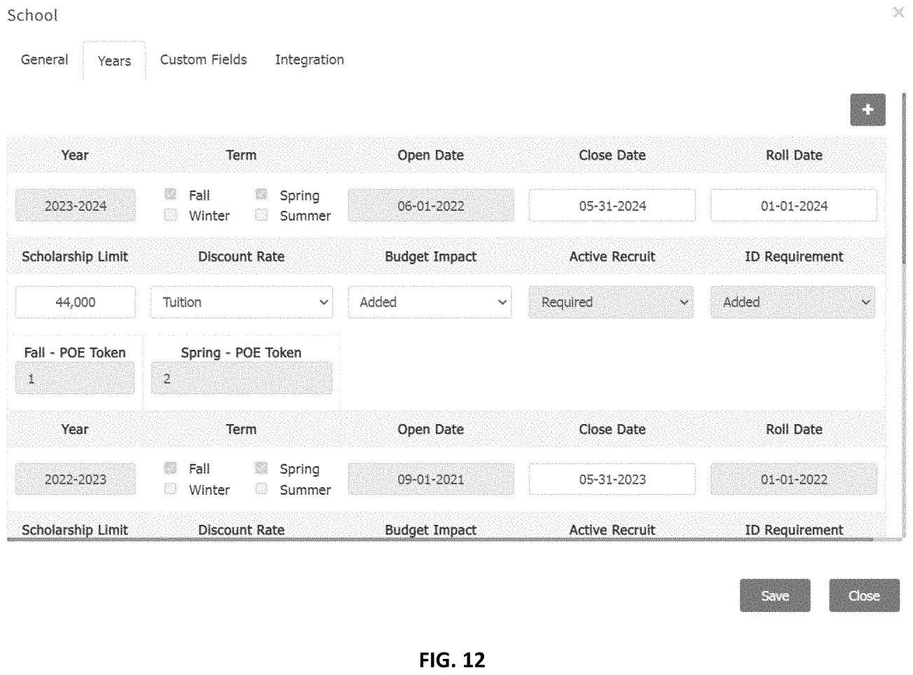

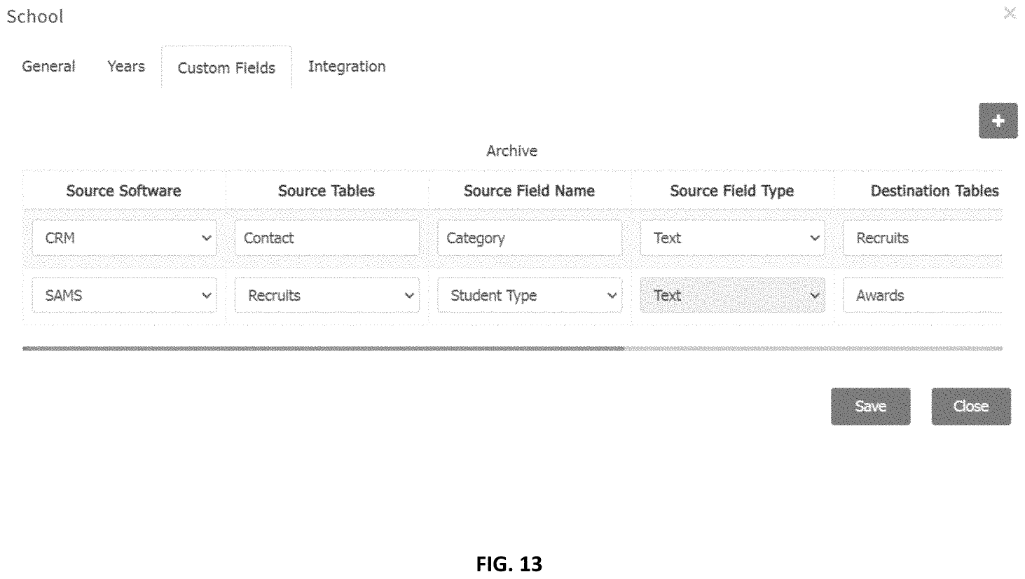

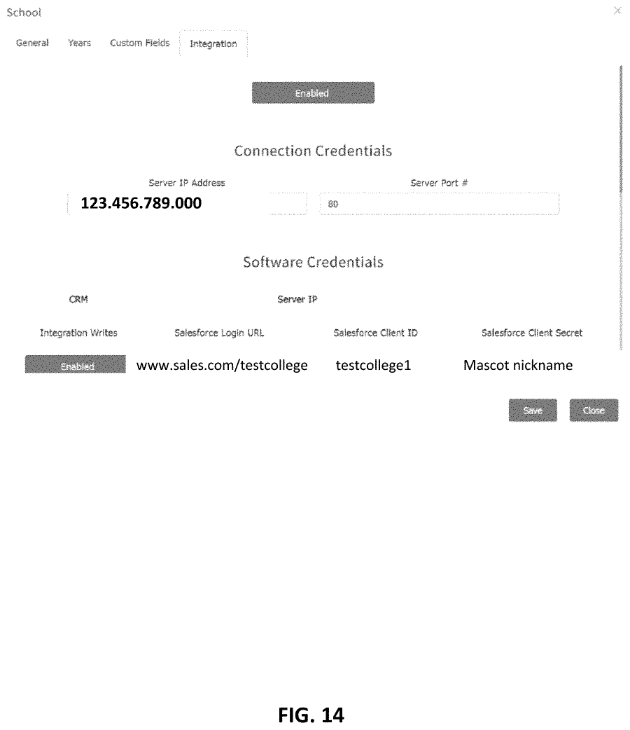

FIGS. 6 to 46 illustrate some exemplary screen shots of a system and method. For instance, FIGS. 6-8 illustrate examples of a high level dashboard or overview screen showing options for high level menu selection on the left and some overview information. FIGS. 6-7 illustrate two examples of a system administrator dashboard. FIG. 8 illustrates an example of a dashboard for a single university. Such an example dashboard may have summaries for a roster of recruits or potential student-athletes, a budget tab, a sport level tab, and a scholarship limit tab to give a university administrator or a coach a high-level overview of the recruiting and scholarship awarding status.

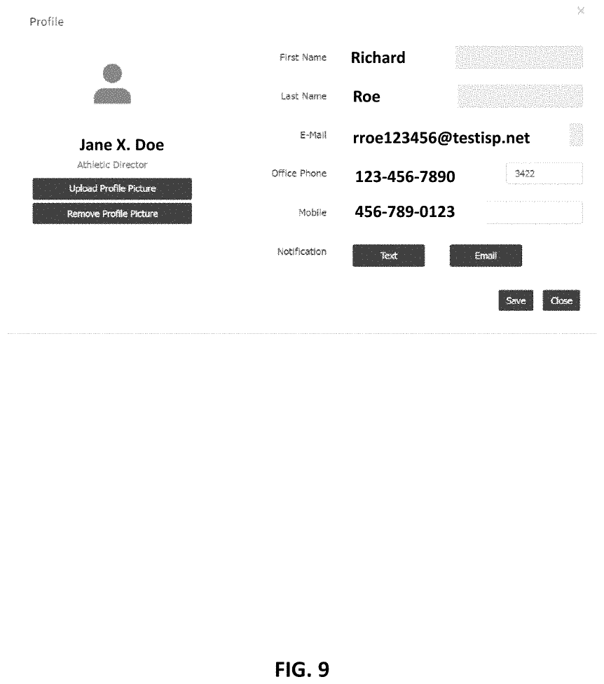

FIGS. 9-14 illustrate example screens and information for a user, optional fields for display, some details about the school or team for a given school year, as well as some customization options available to a user.

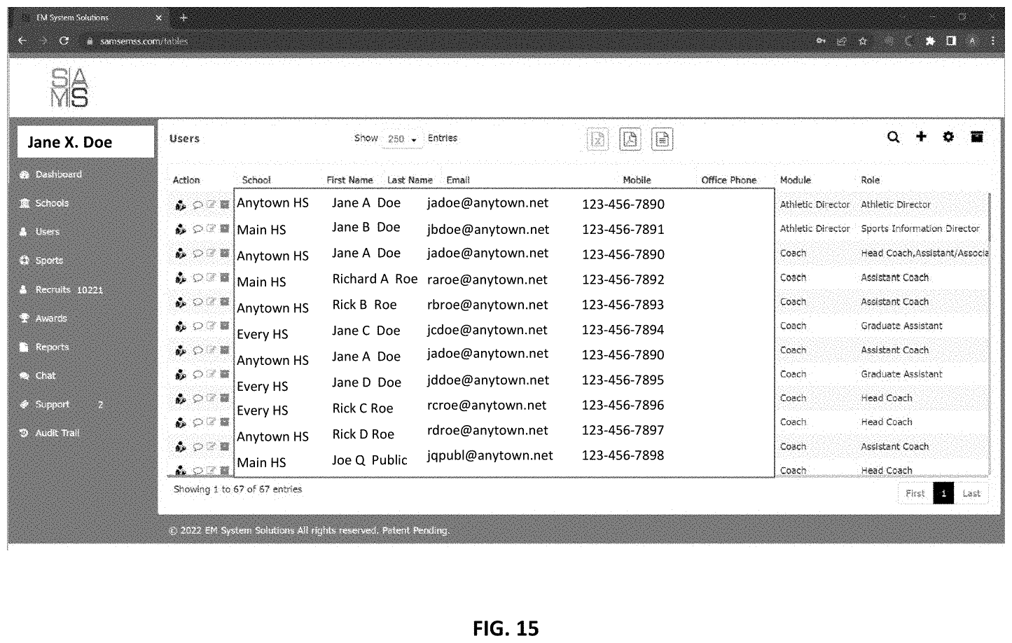

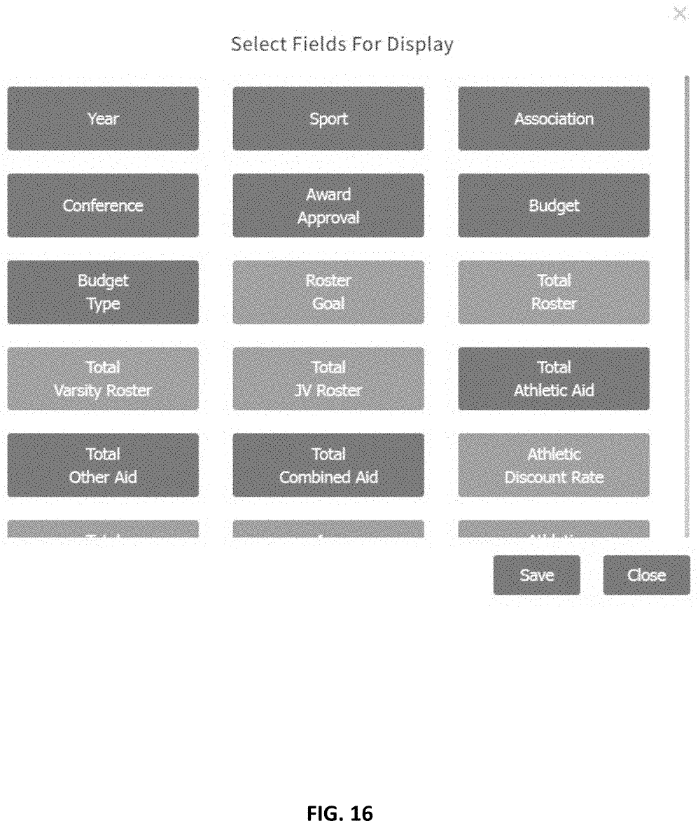

FIG. 15 illustrates an exemplary users overview, for a university system administrator, along with a dashboard on the left side of the screen. The screen may show all the users by name, title, role, and other details. FIG. 16 illustrates some of the options for fields to display on a user's overview screen.

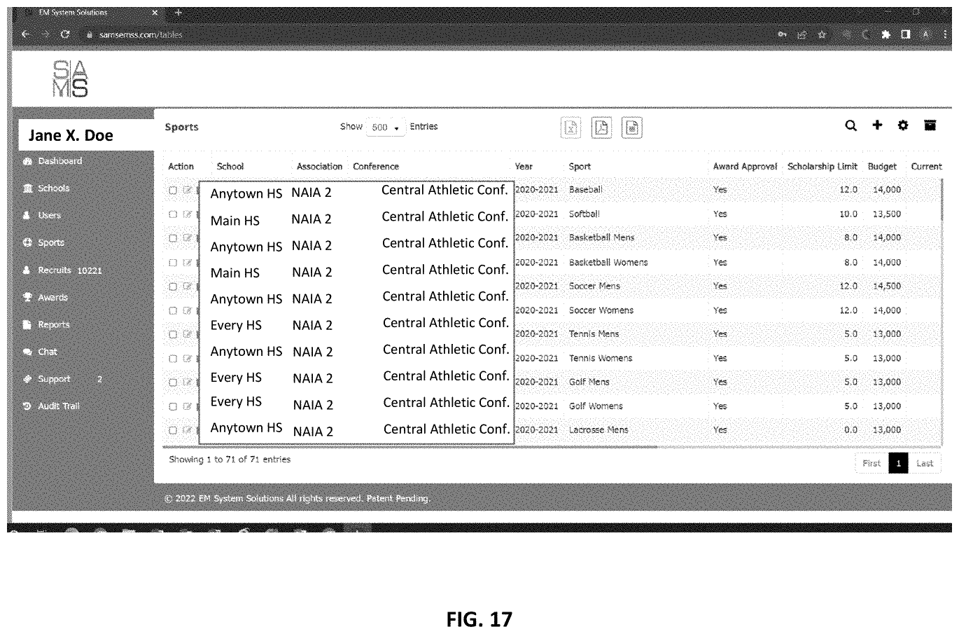

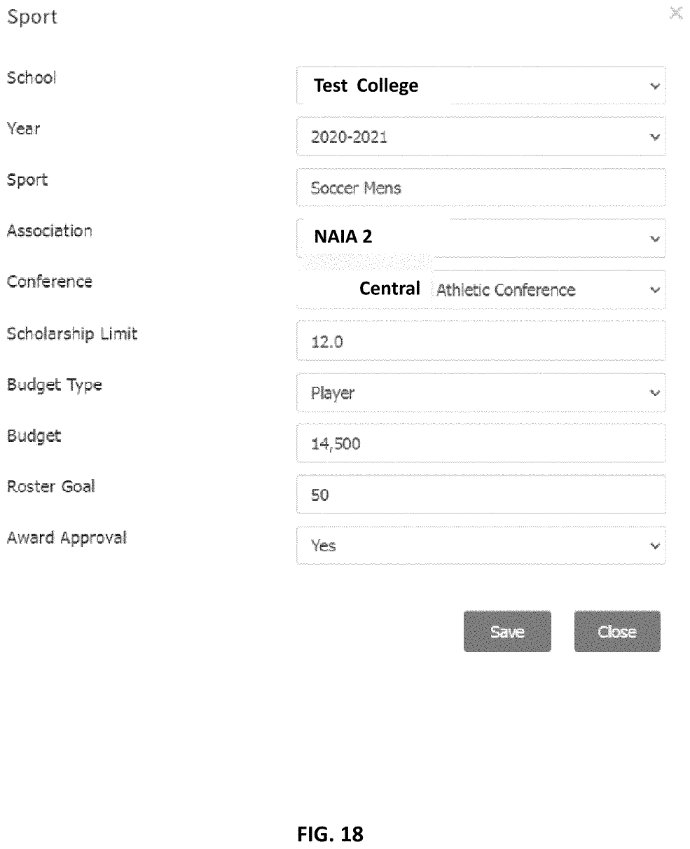

FIG. 17 illustrates an example of the sports page. In this example, each sport is associated with a scholarship limit and a budget amount. FIG. 18 illustrates some options for details about the sport selected. In this example, the school year is selected as 2020-2021, the sport is Men's Soccer.

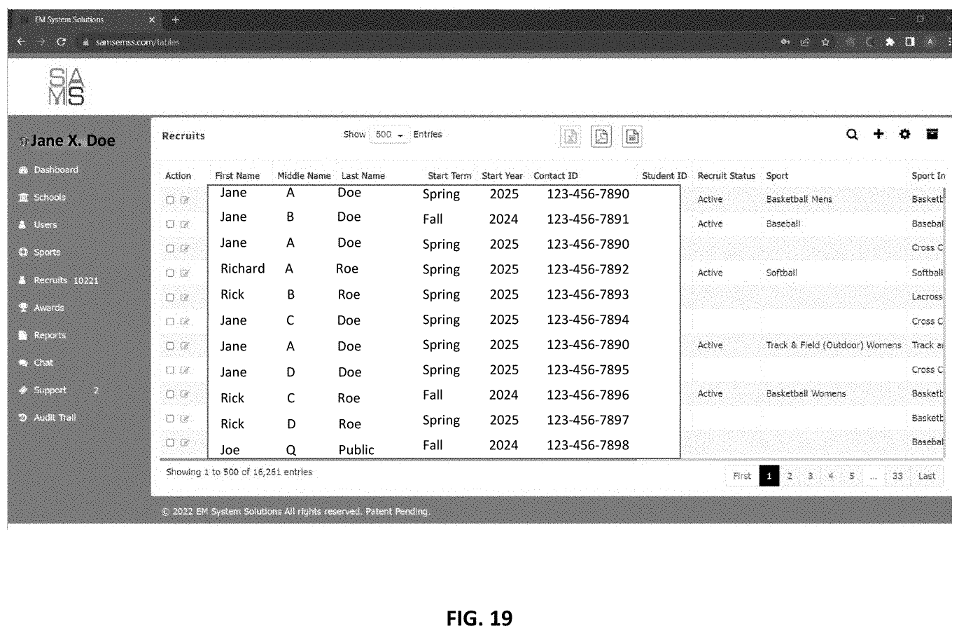

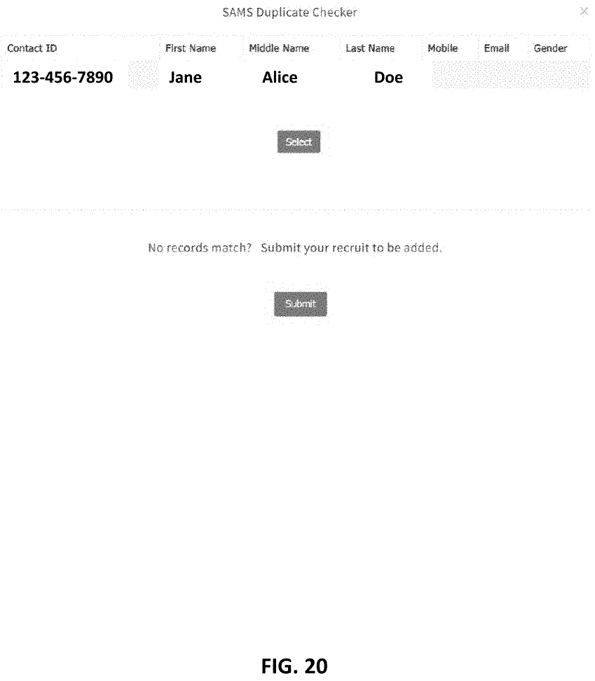

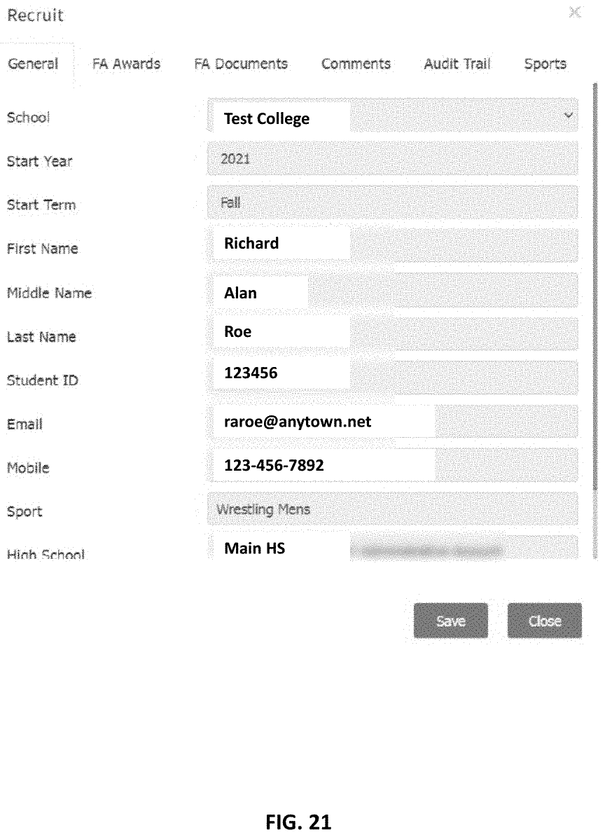

FIGS. 19-27 show details associated with a recruits page. FIG. 19 illustrates an exemplary “Recruits” display. In this example, all recruits are listed by name, start term, start year, contact ID, student ID, status, sport, and other fields related to each person being considered for a scholarship or being recruited by the school sport's team. FIG. 20 illustrates an exemplary duplicate checker to identify whether the same person is listed as two or more separate recruits. This feature may be useful if a recruit is strong in two or more sports and may be recruited for multiple sports. FIG. 21 illustrates an example of fields associated with a recruit. There may be several tabs to help organizer the information associated with each recruit. In this example, the tabs include general information, FA (Financial Aid) Awards, FA documents, comments, audit trail, and sports, but others are also possible, depending on user demand and need. In this example, the school and student's name are redacted, but it shows the start year, start term, contact information, the sport, the student's high school (or high schools, they attended more than one high school), and similar information.

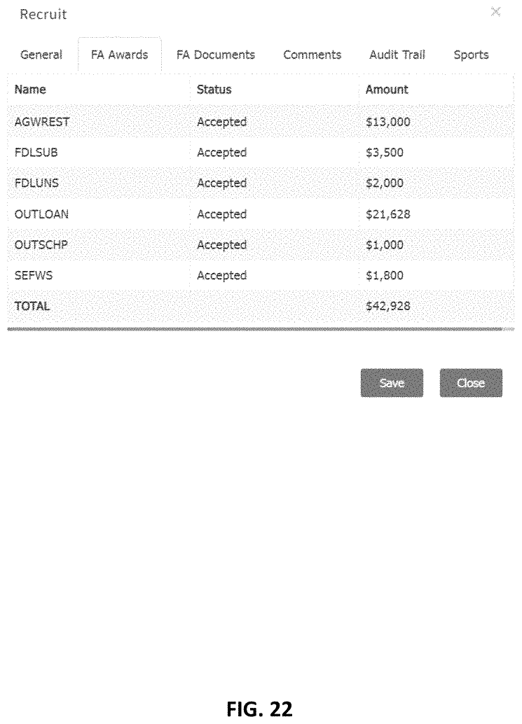

FIG. 22 illustrates some exemplary information from the FA Awards tab for a recruit. In this example, the school has awarded the student several scholarships or other forms of financial aid, along with the status of each award. In this example, the first award is an athletic scholarship for the wrestling team (AGWREST). Additional financial aid is also listed, such as federal scholarships or aid, an outside loan, an outside scholarship, and others. The total aid package for the student in this example is $42,928. Such a system allows an administrator or a coach to see the entire picture of the aid being offered to a student and may help a coach manage recruiting and disbursement of athletic scholarships.

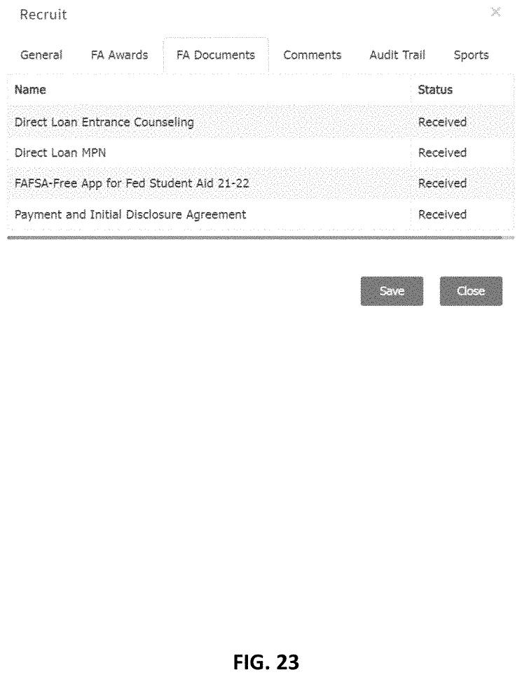

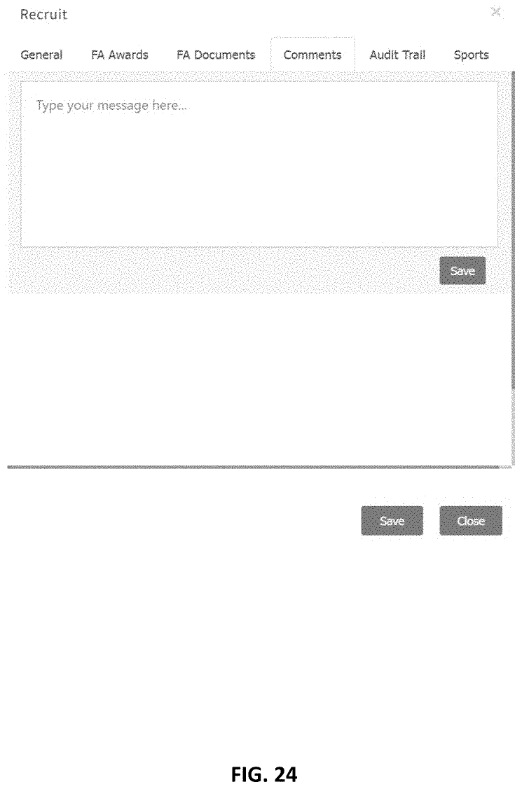

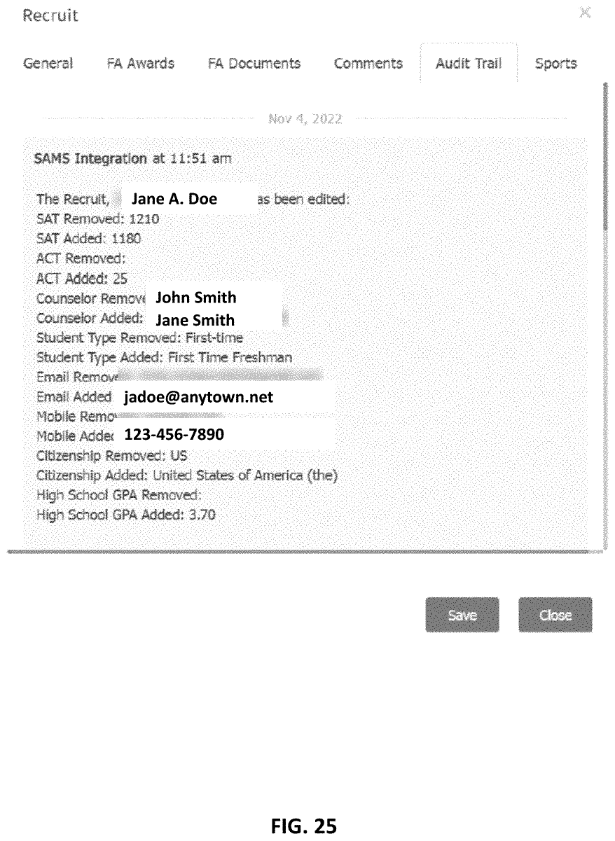

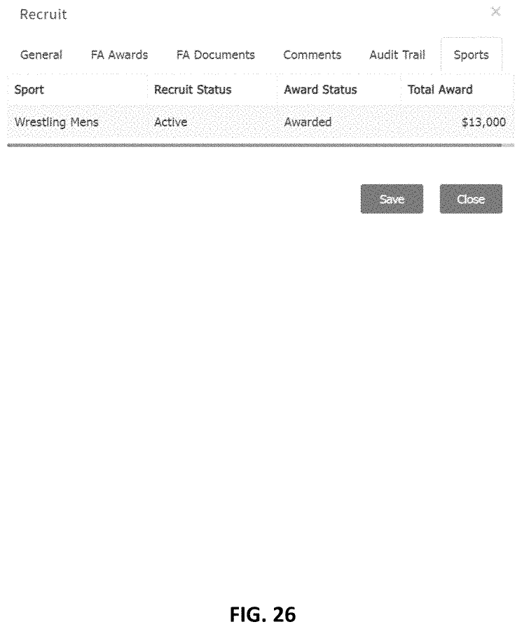

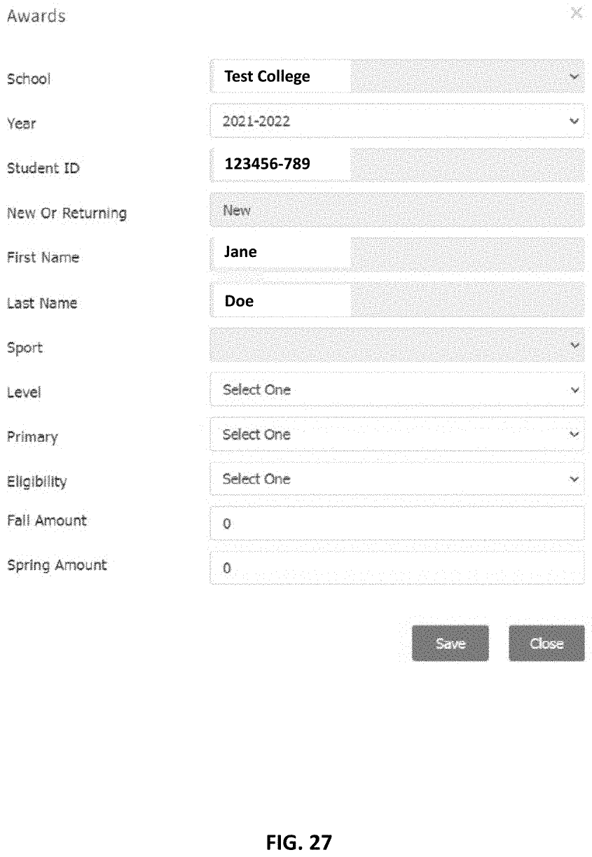

FIG. 23 illustrates some exemplary information related to financial aid (FA) documents. In this example, such information includes direct loan entrance counseling, FAFSA for school year 21-22, and payment documents, though others may also be included. FIG. 24 illustrates an exemplary comments tab related to a recruit. Here a coach or administrator might make notes related to a recruit. FIG. 25 illustrates an exemplary tab with information related to an audit trail. In this example the recruit's name an identifying information have been redacted, but would be available to an administrator or a coach. In this example, the audit trail tab includes information about the recruit's standardized test scores, the counselor, student year, contact information, high school grade point average (GPA), and citizenship. Other information may also be relevant and included in this tab. FIG. 26 illustrates an exemplary Sports tab for the athletic scholarship awards to this student, along with status information about the award. In this example, the award status is “Awarded” but other statuses can include “pending approval” or “sent to student, awaiting response,” “not yet awarded,” “denied,” or some other status assigned by the user. FIG. 27 illustrates an exemplary tab with details about the awards for a particular recruit. Some information fields may comprise level of play, primary sport, eligibility, amount of aid by term, new or returning student, in addition to the student's name and contact information.

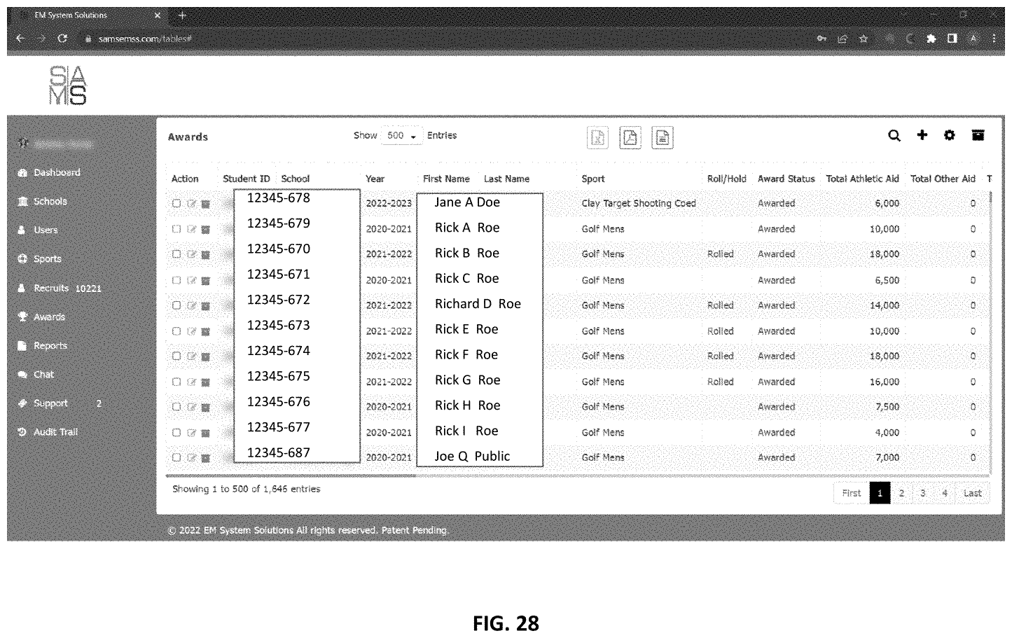

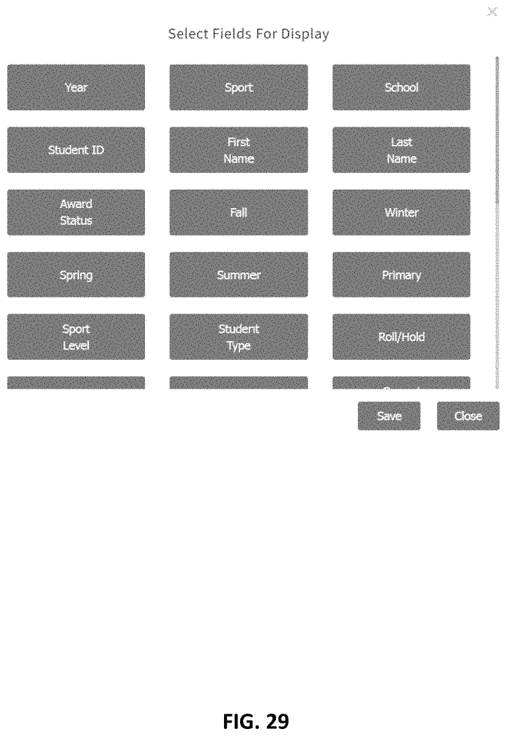

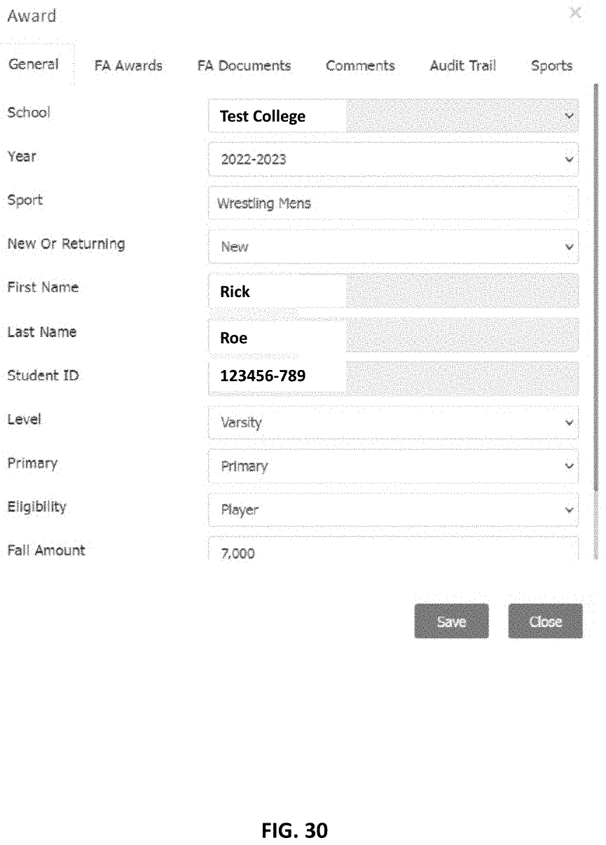

FIGS. 28-34 illustrate examples of information associated with the awards. FIG. 28 illustrates an exemplary overview screen showing the status of various amounts along with the students who have accepted the awards, or the status of the award. In this example the information may comprise student ID, school, school year, student name, sport, roll/hold, award status, total athletic aid, other total aid, or other information. FIG. 29 illustrates some examples of fields which might be displayed. The roll/hold tab is included for a student who intends to continue playing the sport (roll over to next term or year) or a student who may wish to take a term or year off from playing the sport, for instance, due to injury (hold). FIG. 30 illustrates a set of tabs associated with the award including, in this example, general, FA Awards, FA documents, comments, audit trail, and sports, though others may also be included, as needed. In this example, a member of the Men's wrestling team for 2022-2023, wrestles at the varsity level, has wrestling as his primary sport, and has been awarded $7,000 for the fall term.

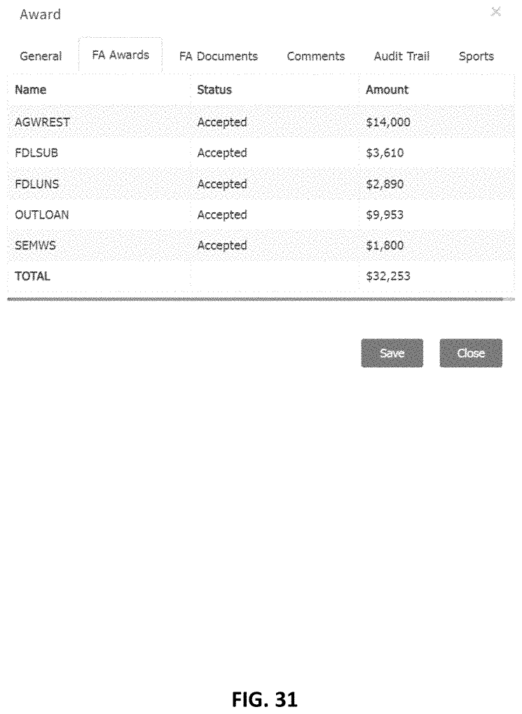

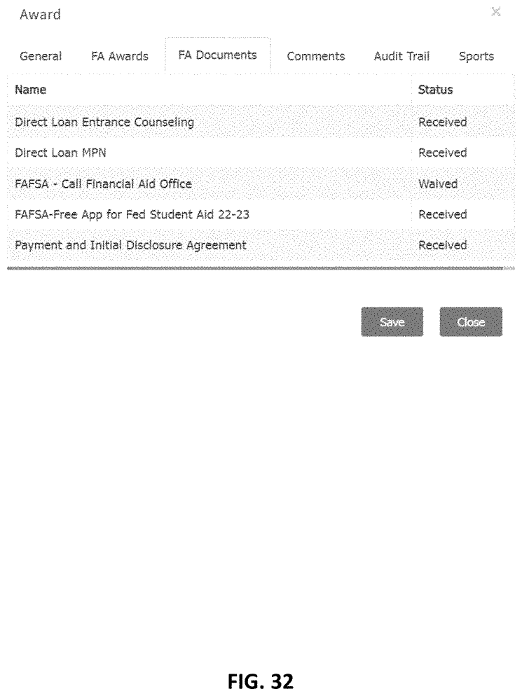

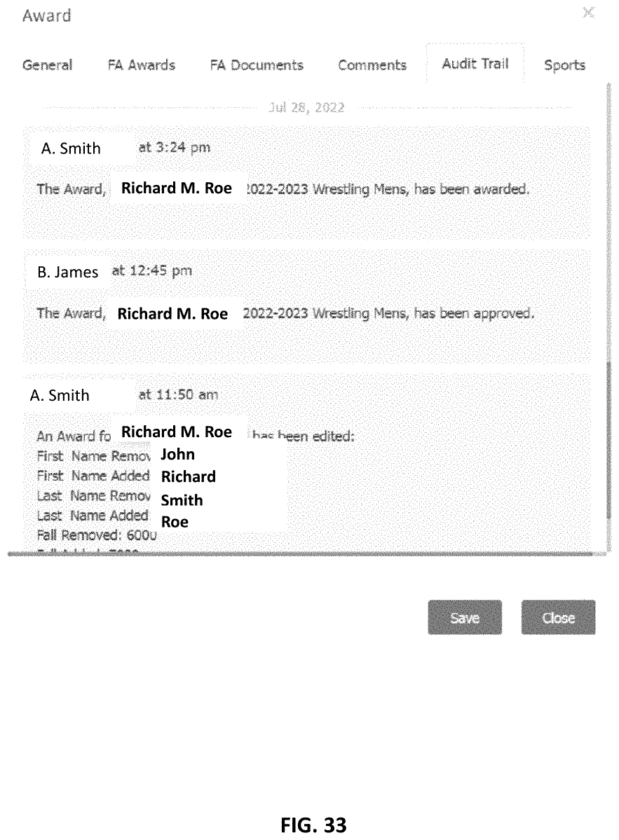

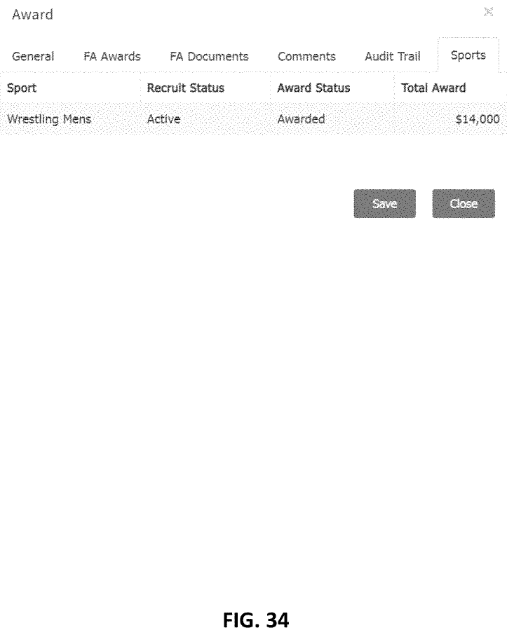

FIG. 31 illustrates an example amount of financial aid, analogous to FIG. 22. In this example, the wrestling team has awarded a $14,000 (annual) scholarship to the student. In addition, there are various federal loans, an outside loan of $9,953, and a semester work-study amount of $1,800. In this example the total amount of aid awarded to the student is $32,253. FIG. 32 illustrates an example list of FA-related documents along with the status of various documents. In this example the document or status. FIG. 33 illustrates an example of information on the Audit Trail tab, analogous to FIG. 25. In this example, various messages are included such as the creation of the award (at 11:50 am by A. Smith), the approval of the award (by B. James at 12:45 pm), and the sending of the award to the recruit by A. Smith at 3:24 pm. In this manner, the status of the award may be easily tracked. FIG. 34 illustrates an example of the award related to the sport, analogous to FIG. 26.

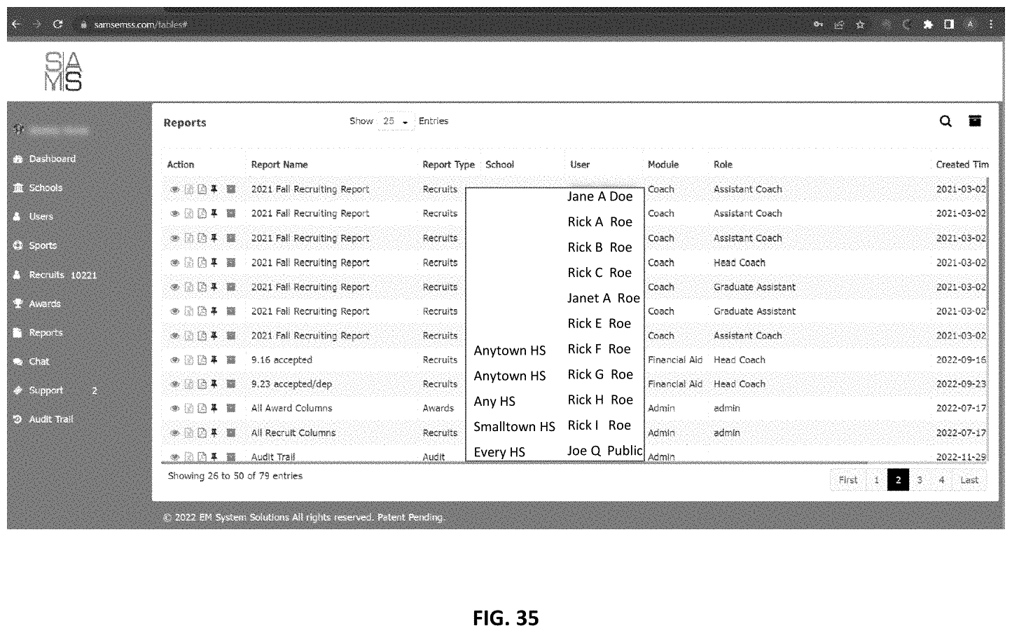

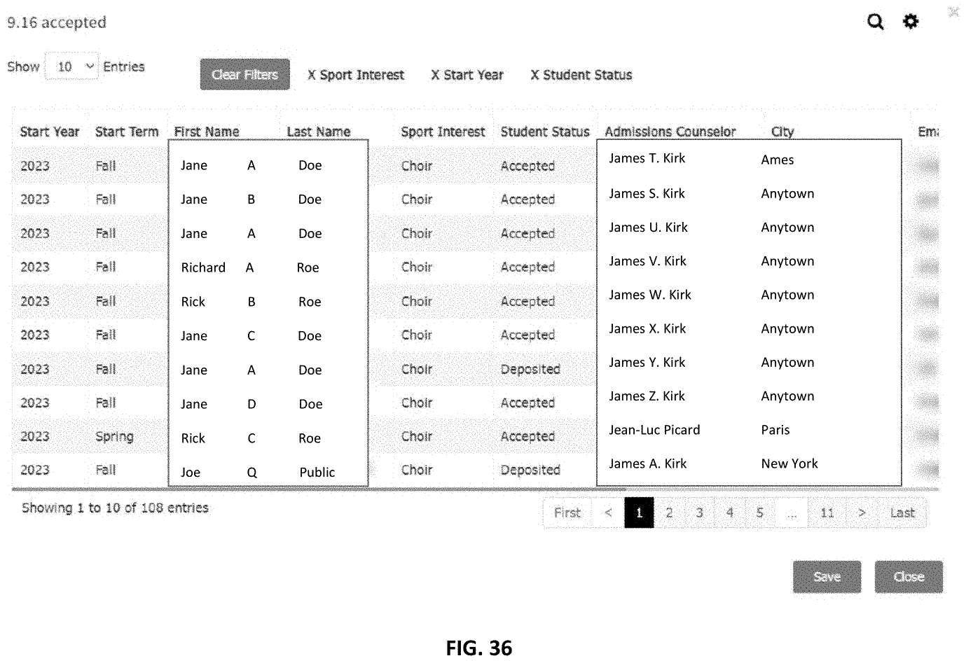

FIG. 35 illustrates some exemplary reports which the system may generate automatically upon request by a user. In this example, there is a 2021 Fall Recruiting Report, which was created or requested by various users, in various roles (e.g. assistant coach, head coach, administrator). In addition, the various users may be submitting information for such reports or may be requesting the generation of a report. By selecting or double clicking on a particular report, that report may be displayed, as shown in the example of FIG. 36. FIG. 36 illustrates the report labelled 9.16 accepted in FIG. 35. In general, a report may include filters to seek out particular information or to exclude irrelevant information. In the example in FIG. 36, the filters used are “sport interest,” “start year,” and “student status.” Other filters may also be used. In this example, the report may include a list of all the students who have accepted their offers, or all the offers which were made along with the student status of each offer. In this example, the student status may be listed as “accepted” or “deposited” but other descriptors may also be included.

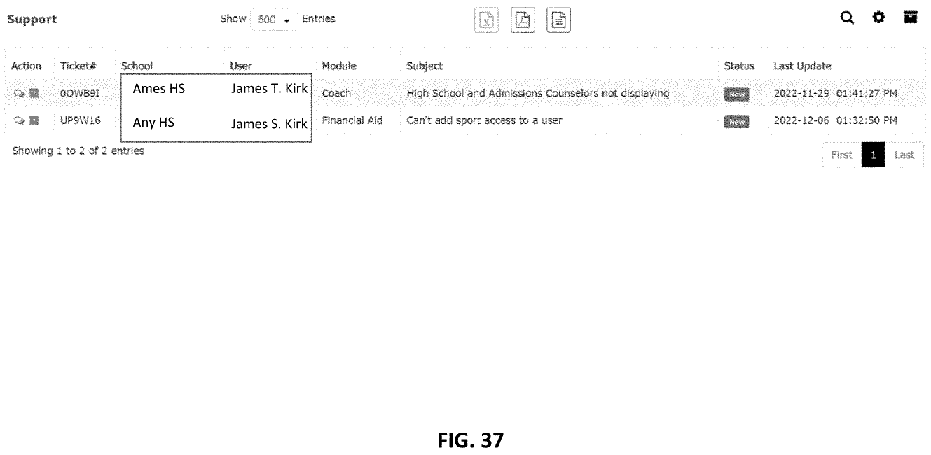

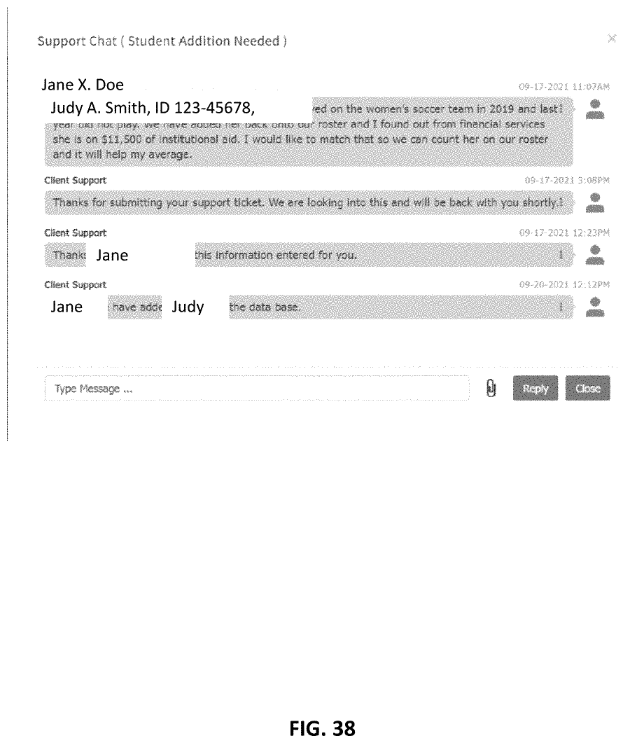

FIGS. 37-38 illustrate examples of support screens. In this example, a user may send a message to an administrator requesting help or reporting a bug. FIG. 37 illustrates an example of all requests for help and responses provided. FIG. 38 illustrates a support chat dialogue.

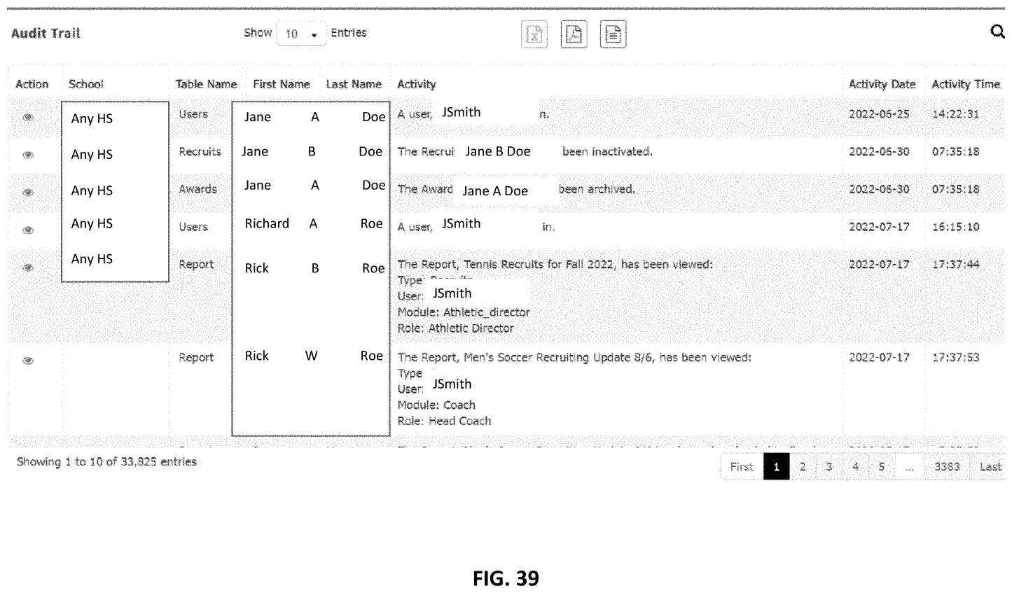

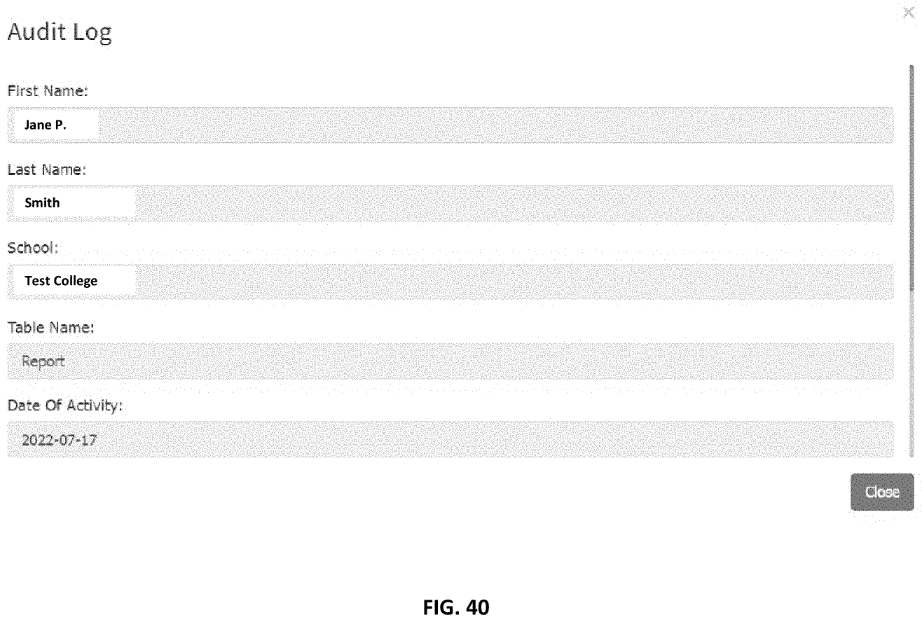

FIGS. 39-40 illustrate some exemplary displays of information related to an audit trail and other aspects. FIG. 39 illustrates some of the items which may be tracked using this system. These tracked items may include when each user has logged on to the system, when a recruit has been inactivated, when a recruit or award has been archived, when a report has been requested or viewed. FIG. 40 shows an example of an Audit Log.

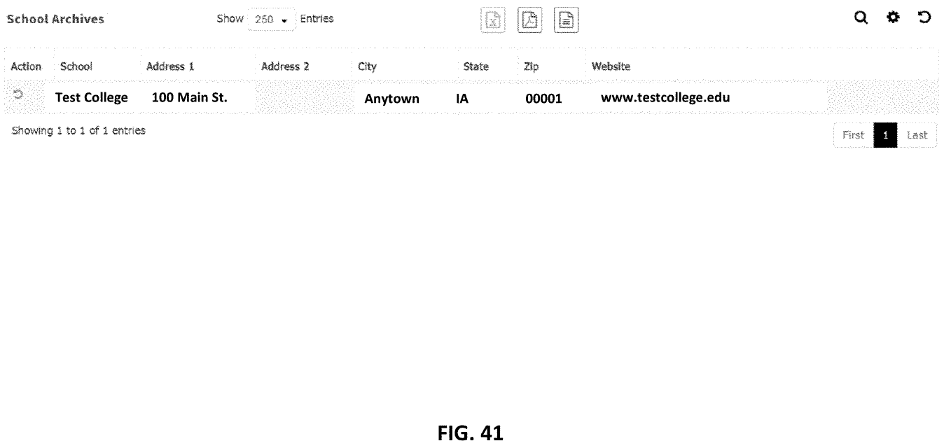

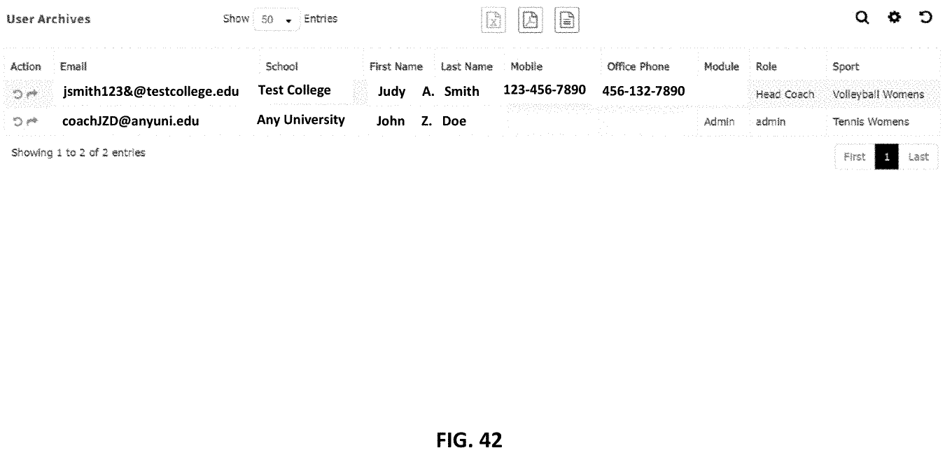

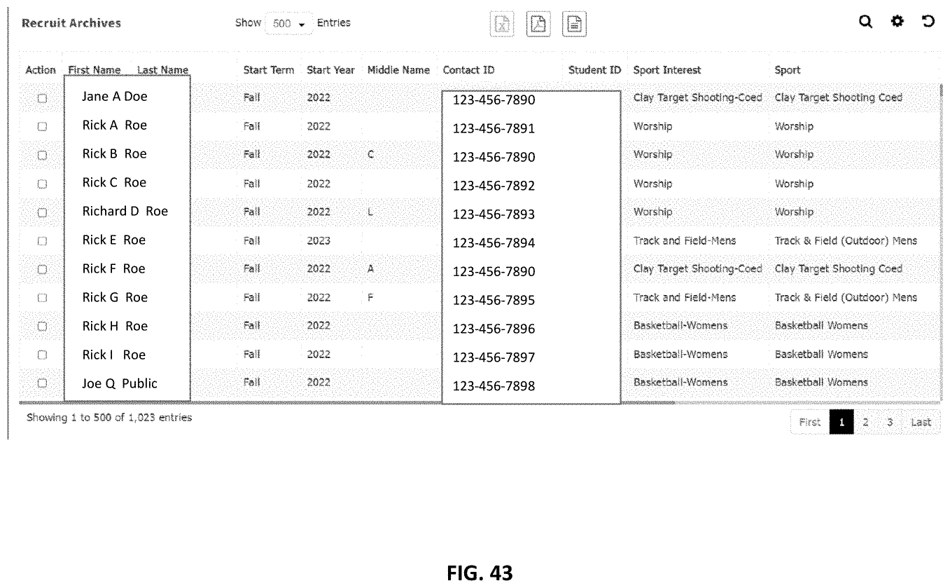

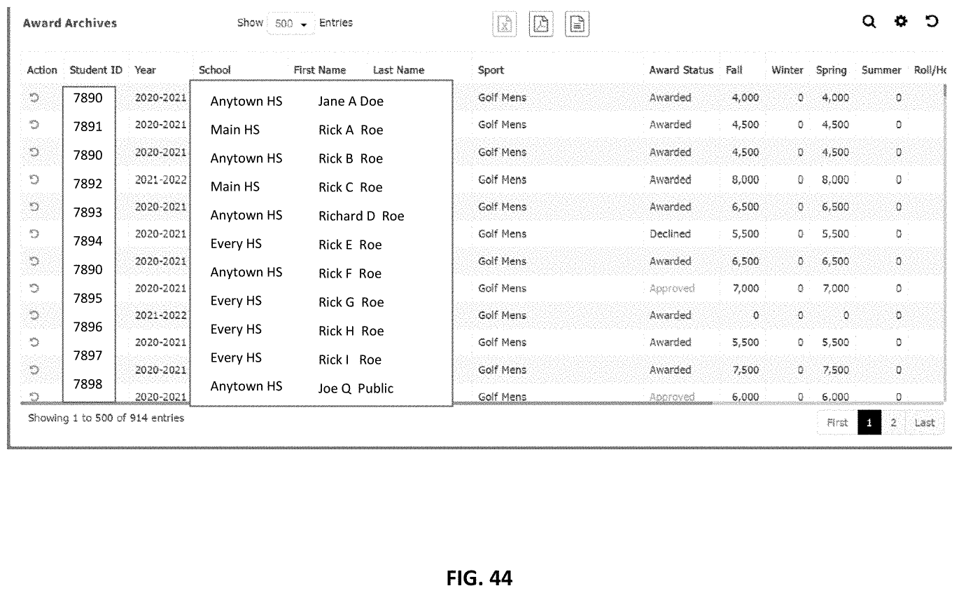

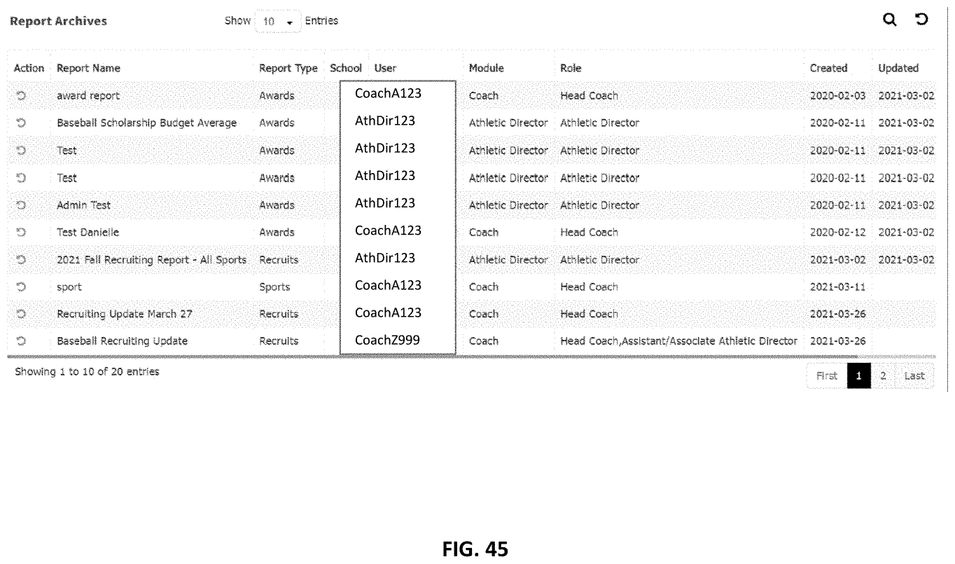

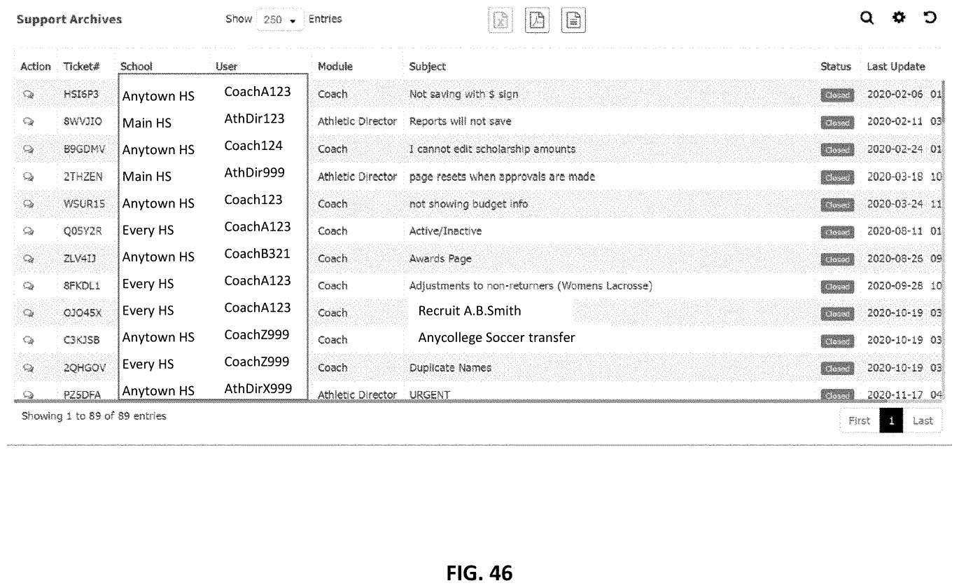

FIGS. 41-46 illustrate examples of archives. FIG. 41 illustrates an example of a school which has been archived by the system. FIG. 42 illustrates an example of a user archive. FIG. 43 illustrates an example of recruit archives. FIG. 44 illustrates an example of award which have been archived. FIG. 45 illustrates an example of a report archive. FIG. 46 illustrates a support archive.

The system allows a user to enter recruit information and to match recruits to appropriate financial opportunities including scholarships and awards. The system further allows a user to track a recruit or a scholarship/financial opportunity and to match them up and also to run hypothetical scenarios, such as what happens if 75% of a team's athletic scholarship awards are evenly allocated to all members of the team and 25% of the athletic scholarship awards are based on an assessment of the value each athlete brings to the team?

There are many matching algorithms and they mostly rely on using a matching function. With an overall constraint in place, the matching algorithm can try to pair up students with funding opportunities and then calculate how it would affect a team's discount rate or how it would affect an entire school slate's worth of discount rates. An alternative with this system and method further comprises assigning a fitness metric or a weighting for each athlete who may be assigned a scholarship, and then allowing the system to calculate, for instance, the team discount rate. The system may also comprise tracking recruitment in order to answer questions such as how many of the most highly valued recruited students end up matriculating and playing on the team.

Resource allocation may occur in several separate ways. The first allocation occurs when non-academic scholarships are divided amongst various departments (e.g. athletics, music, etc.). The method enables optimization of this particular resource by coalescing information (summarizing and collating) from different departments awarding scholarships and the administrative departments (e.g. admissions, financial aid, etc) involved in the awarding process. This all happens in a shared platform that can manage the information, the calculations, and facilitate communications throughout the awarding process.

The second resource is the allocation of man-hours required to perform these calculations and the mandatory reporting associated with regulatory bodies or associations. The centralization of this information and the associated calculations significantly reduces the need for human hands to write down information and then enter it into a computer and submit to a centralized database.

By using this system or method coaches and administrators may be presented the full picture of financial aid provided by the university to one student at a single time and place. Analogously, the system may present the entire picture of a university sports team at one time to a user. This enables the coach to allocate the team's scholarship money most effectively. For instance, a coach may have a great need for a particular position on the team and may want to weight those recruits with the requisite skill more highly than other recruits in other positions on the same team. For instance, a softball team may need a new pitcher. In a particular year, the coach may assign a higher value to recruiting a new pitcher, so that pitcher recruits may be assigned a greater weight. In the same year a softball team may have a lesser need for an outfielder and athletic scholarships offered may reflect these different needs in that particular year. This system may help assign funding opportunities to those that provide the highest marginal benefit to a school.

Displaying the Status in Real Time

Net tuition revenue per student is an input to the calculation of the discount rate. In an example, a coach may know of a recruit with a good GPA and high standardized test scores who is eligible for significant academic-based financial aid. In this example the recruit wants to play at the junior varsity level. Adding this recruit and offering a modest athletic scholarship may improve the overall team's discount rate, as well as the university's overall discount rate for athletes. In this example, a coach could assign a lower weight to such a recruit due to these other factors.

One significant cost is the cost to recruit and “acquire” the athlete. If a team's discount rate is high, the root cause may be that the that team's recruiting money is not being spent effectively or efficiently. Such information is quite valuable to university administrators and athletic directors for managing the overall effort. If the amounts offered to students are too low, then too few student-athletes will attend that school. By providing coaches, athletic directors, and university administrators a real time overview of the status of all students receiving a funding opportunity, and combining the disparate sides of the financial aid picture in a single location, new insights may be gained, and the actions may be taken to correct funds which may be mis-allocated. The system is able to provide the entire picture at any time during the academic year.

The discount rate or discounted rate of tuition or discounted rate of term bill may be defined several ways. In an example, we may define the discount rate (DR) as the sum total of all scholarship money awarded by an institution. The DR may also be defined for an individual student, a team, a sport, a sub-set of teams, or for the institution as a whole. For an institution the DR may equal total aid offered all students by the university divided by the total cost to attend for all students. Analogously, the DR for a sport or team may include the sum of all aid offered to the athletes on the team divided by the total cost to attend of the entire team. An example is given in FIG. 1. Although the discount rate has been emphasized in this disclosure, it is an example of a metric which may be used to help coaches and administrators oversee and manage the entire process of assigning funding to students.

As part of the management of these financial awards and the matching of awards to students, the institution must comply with numerous regulations and rules. As an example, the NCAA may have a rule that if a student meets a minimum GPA (e.g. GPA≥3.5) and standardized test scores (e.g. ACT≥25, SAT≥1200) then that student may awarded an academic scholarship and not have it count against them for a purely athletic award. Again, in an example, if a student does not meet these requirements, then any nominally “academic” award will be counted as if it were an “athletic” award. Such rules and regulations may be integrated into this system to provide instantaneous knowledge to a user about each recruit or current student. In another example the NCAA may have rules which require some teams to award no more scholarships to individuals than a threshold number, but for other sports/teams the sum of all awards cannot exceed a dollar amount or cannot exceed a dollar amount on average per athlete on the team. These are only examples but they are modified from time-to-time, and the system will reflect the current known rules and regulations in order to be able to update users.

Computing Aspects

Many operating systems, including Linux, UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. Thus, it is impossible for any program to damage the execution of any of the other programs running on the system. However, the programs have no way to exchange any information except through the operating system (or by reading files stored on the file system).

Multi-process computing is similar to multi-tasking computing, as the terms task and process are often used interchangeably, although some operating systems make a distinction between the two. The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The method, system, or computer program product may require the use of a computing device 4700, as depicted in FIG. 47. The computing device 4700 may comprise input/output component(s) 4702 such as a computer mouse, a display, a keyboard, a microphone, speakers, and the like. The computing device may comprise a central processing unit (CPU) 4704, a network adapter 4706, and memory 4710. The network adapter 4706 may connect to a network 4708, which may connect to an external device or to multiple external devices 4750. Such external devices 4750 may include, but are not limited to, other computers, servers, databases, phones, tablets, notebooks, and any other electronic devices which may be connected to a network. The computing device 4700 may also include, but is not limited to a mobile phone, a tablet, a laptop computer, a notebook computer, a desktop computer, or any other computing device.

In the computer memory 4710 there may reside a number of programs, routines, and data. For example, the memory 4710 may comprise a database of students being actively recruited by a university 4712. Memory 4710 may comprise a current athlete database (4714), a funding opportunity or scholarship database 4716 in addition to other databases. For instance, an external device 4750 may comprise a database of regulations or a storage of a regulatory body, to which reports on the financial status of student athletes must be filed. In the computer memory 4710 there may also be stored regulatory requirements 4718, financial requirements 4720, and activity or sport needs 4722. Memory 4710 may also comprise an algorithm 4724 or a set of algorithms. For instance, memory 4710 may comprise a matching algorithm for matching the recruits in the recruit DB 4712 with the funding opportunities in the funding opportunities DB 4716. The algorithm or algorithms 4724 may also match recruits with funding opportunities subject to some constraints, for instance, limiting the search to a team funding cap or limiting the matching based on meeting a team discount rate cap. An operating system 4726 resides in memory to allocate resources as required from amongst the components of the computing device 4700.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire. Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s).

In some alternative implementations, the functions noted in the blocks may occur out of the order noted in the Figures. For example, two blocks shown in succession may, in fact, be executed substantially concurrently, or in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or that carry out combinations of special purpose hardware and computer instructions. Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

From the above description, it can be seen that the present invention provides a system, computer program product, and method for the efficient execution of the described techniques. References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

While the foregoing written description of the invention enables one of ordinary skill to make and use what is considered presently to be the best mode thereof, those of ordinary skill will understand and appreciate the existence of alternatives, adaptations, variations, combinations, and equivalents of the specific embodiment, method, and examples herein. Those skilled in the art will appreciate that the within disclosures are exemplary only and that various modifications may be made within the scope of the present invention. In addition, while a particular feature of the teachings may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.”

Other embodiments of the teachings will be apparent to those skilled in the art from consideration of the specification and practice of the teachings disclosed herein. The invention should therefore not be limited by the described embodiment, method, and examples, but by all embodiments and methods within the scope and spirit of the invention. Accordingly, the present invention is not limited to the specific embodiments as illustrated herein, but is only limited by the following claims.

What is claimed is:

1. A system comprising:
a first database comprising a plurality of recruits;
a second database comprising a plurality of funding opportunities;
a computing device comprising a display and in communication with the first database and with the second database;
the computing device to perform a method comprising:
matching a recruit of the plurality of recruits with a funding opportunity of the plurality of funding opportunities;
calculating, using the matched recruit and the matched funding opportunity, a metric; and
displaying the metric to a user.

2. The system of claim 1, wherein, the computing device comprises at least one of a mobile phone, a tablet, a desktop computer, a laptop computer, or a notebook computer.

3. The system of claim 1, wherein the metric comprises a discount rate.

4. The system of claim 1, wherein the matching step further comprises an algorithm to optimize a fitness metric.

5. The system of claim 1, further comprising tracking an interaction between a recruit of the plurality of recruits and a user and storing a record of the interaction to provide an audit trail.

6. The system of claim 1, further comprising automatically displaying additional information as the additional information is added to either the first database or the second database.

7. A method for matching recruits to funding opportunities comprising:
generating a first database comprising a plurality of recruits;
generating a second database comprising a plurality of funding opportunities;
matching, on the computing device, each recruit of the plurality of recruits with a funding opportunity of the plurality of funding opportunities;
calculating, on the computing device, using the plurality of matched recruits and funding opportunities, a metric; and
displaying the metric to a user.

8. The method of claim 7, wherein the computing device comprises at least one of a mobile phone, a tablet, a desktop computer, a laptop computer, or a notebook computer.

9. The method of claim 7, wherein the metric comprises a discount rate.

10. The method of claim 7, wherein the matching step further comprises the use of an algorithm to optimize a fitness metric.

11. The method of claim 7, further comprising tracking an interaction between a recruit of the plurality of recruits and a user and storing a record of the interaction to provide an audit trail.

12. The method of claim 7, further comprising automatically displaying additional information as the additional information is added to either the first database or the second database.

13. A computer program product for matching recruits to funding opportunities comprising:
generating a first database comprising a plurality of recruits;
generating a second database comprising a plurality of funding opportunities;
matching, on the computing device, each recruit of the plurality of recruits with a funding opportunity of the plurality of funding opportunities;
calculating, on the computing device, using the plurality of matched recruits and funding opportunities, a metric; and
displaying the metric to a user.

14. The computer program product of claim 13, wherein the computing device comprises at least one of a mobile phone, a tablet, a desktop computer, a laptop computer, or a notebook computer.

15. The computer program product of claim 13, wherein the metric comprises a discount rate.

16. The computer program product of claim 13, wherein the matching step further comprises the use of an algorithm to optimize a fitness metric.

17. The computer program product of claim 13, further comprising tracking an interaction between a recruit of the plurality of recruits and a user and storing a record of the interaction to provide an audit trail.

18. The computer program product of claim 13, further comprising automatically displaying additional information as the additional information is added to either the first database or the second database.
